(19) United States
(12) Patent Application Publication
(10) Pub. No.: US 2006/0169791 A1
(43) Pub. Date: Aug. 3, 2006

(54) Sip straw with consumable component

(76) Inventors: Eve F. Taylor, New York, NY (US); Paul D. Taylor, New York, NY (US)

Correspondence Address: Bernard Malina;Malina & Associates, P.C., Suite 501, 60 East 42nd Street, New York, NY, 10165, US

(21) Appl. No.: 11/047,998

(22) Filed: Jan. 31, 2005

(51) Int. Cl. E03B 9/20; A47G 21/18; A61J 15/00

(52) U.S. Cl. 239/33; 239/16

(57) ABSTRACT

A sip straw includes an outer tubular member and an inner tubular member. The outer tubular member is formed of a spirally wound paper wrapper which is wound onto the outer surface of the inner tubular member. The inner tubular member is formed of an edible substance such as chocolate, which imparts a flavor to a fluid being drawn through the inner tubular member by a user.

### FIELD OF THE INVENTION

The present invention relates generally to the field of sip straws for consuming beverages and more particularly, to a sip straw having a consumable component.

### BACKGROUND OF THE INVENTION

The prior art related to sip straws includes the following U.S. patents.

U.S. Pat. No. 6,482,451 B1 to Baron for an Apparatus for Producing a Flavored Beverage shows an elongated receptacle or straw having end caps which contain a flavoring agent in the form of a plurality of flavoring granules. The end caps act as filtration members which contain the granules within the receptacle. The filtration members include perforated caps. The perforations are sufficiently large to allow relatively unimpeded passage of liquid through the straw while small enough to retain the flavoring granules.

U.S. Patent Application No. 2002/0185547 A1 to Kaplan for a Straw for Sipping Liquid includes a tube, a base which depends from the tube and protrusions that depend from the base. The protrusions allow a user to crush and mix sugar granules in a liquid which can then be drawn upward through the tube.

U.S. Pat. No. 6,109,538 to Villani, et al. for a Flavoring Delivery Drinking Straw shows an elongated tube with a spaced apart pair of screens mounted in the lumen of the tube. The screens block passage of objects grated than a predetermined size through the lumen of the tube. The tube contains a flavoring object which is disposed between the screens for imparting flavor to a liquid passing through the lumen of the tube.

U.S. Patent No. 2004/0046042 A1 to Judd for a Flavor Enhancing Drinking System shows a straw semi-embedded into a candy component. The device includes an aperture at a point below the candy component for drawing fluid through the straw and the candy component. The straw is designed to fit a fluid holding container which can be stacked into a second fluid holding container with a straw and candy component inserted.

U.S. Pat. No. 4,921,713 to Fowler for a Versatile Controlled Flavor Straw Assembly includes a straw which contains an intermediate section containing flavor imparting material which has an area greater than the chamber in which it is enclosed. The intermediate section has alternative forms which include (1) a hollow cylinder mounted within the straw and spaced away from the walls thereof; (2) a separate enlarged chamber containing flavor material; (3) granular material held in the straw by a pair of sponges; (4) a reentrant flavor imparting liner having an irregular surface; and (5) a plurality of granules with time delay coatings.

Despite the developments of the prior art, there remains a need for a sip straw with a consumable component.

### OBJECTS AND SUMMARY OF THE INVENTION

It is an object of the present invention to provide a sip straw which encloses a consumable food or candy component.

Another object of the present invention is to provide a sip straw with a consumable component which the user can use to sip a beverage while enjoying flavoring received from an internal tubular component.

Another object of the present invention is to provide a sip straw with a consumable component in which a frangible outer tubular component can be broken away to reveal an inner consumable tubular component.

Yet another object of the present invention is to provide a sip straw with a consumable component which comprises a small number of components which can be manufactured economically in volume resulting in a relatively low unit cost.

The foregoing and other objects and advantages of the invention will appear more clearly hereinafter.

In accordance with the present invention, there is provided a sip straw with a consumable component which includes an outer tubular member and an inner tubular member. The outer tubular member is preferably formed of a water resistant spirally wound paper wrapper which is wound onto the outer surface of the inner tubular member. The inner tubular member comprises an edible component preferably in the nature of a candy material such as chocolate, which imparts a flavor to a fluid which is drawn through the inner tubular member by a user. The consumable component may comprise a wide variety of materials including but not limited to, nutritional materials such as vitamins, minerals and/or other nutrition enhancers.

### DESCRIPTION OF THE DRAWINGS

Other important objects and advantages of the invention will be apparent from the following detailed description, taken in connection with accompanying drawings in which:

FIG. 1 is an elevational side view of a sip straw with a consumable component made according to the present invention,

FIG. 2 is a side view of the sip straw with a consumable component of FIG. 1 taken along the line 2-2 of FIG. 1;

FIG. 3 is an elevational view similar to FIG. 1 with a portion of the outer tubular member shown partially unwrapped; and

FIG. 4 is an end view of the sip straw with a consumable component of FIG. 1 taken along the line 4-4 of FIG. 2.

### DETAILED DESCRIPTION OF THE INVENTION

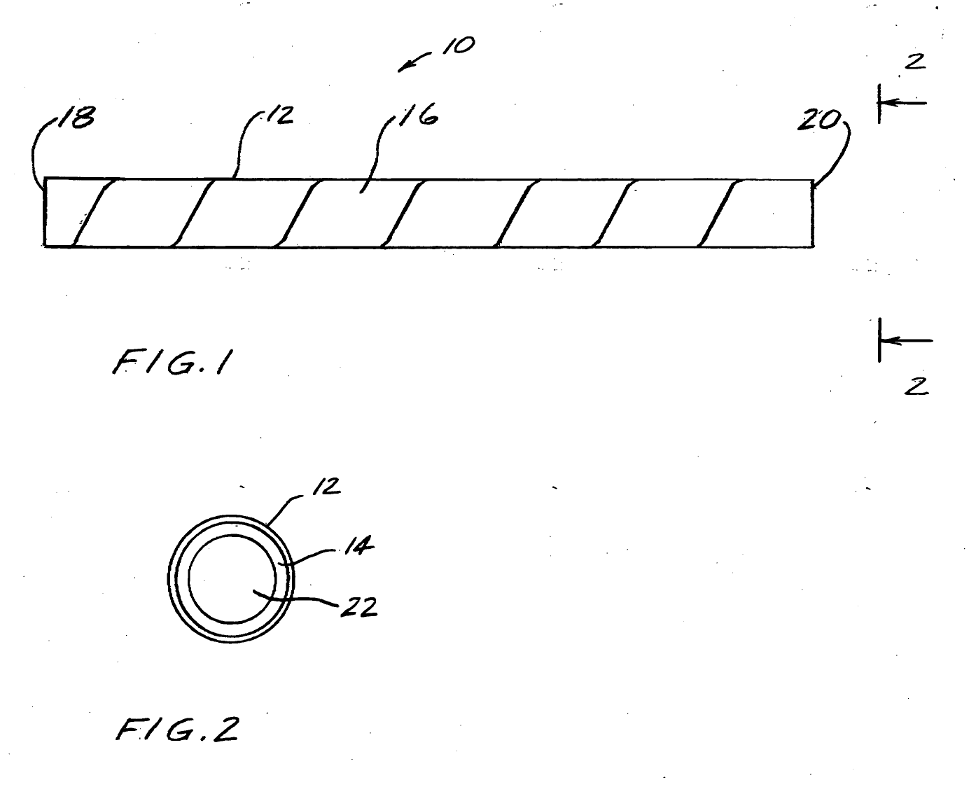

With reference to the drawings, there is shown in FIGS. 1-4 a sip straw with a consumable component 10 made according to the present invention which includes an outer tubular member 12 and an inner tubular consumable or edible member 14.

The outer tubular member 12 is preferably formed of a water resistant paper wrapper strip 16 of extended length 16. The paper wrapper strip is spirally wound to form a tube in a manner similar to a conventional paper drinking straw. The outer tubular member 12 is wound onto the outer diameter 18 of the edible tubular component 14.

The edible tubular component 14 is preferably in the nature of a candy material such as chocolate or other candy flavor. Alternatively, the edible tubular member 14 may be formed of a non-candy food, medicinal material which can be consumed, or nutritional material such as vitamins, minerals and/or other nutrition enhancers.

During us, the user sucks into an end 18, 20 of the outer tubular member 12 in the same manner that conventional paper and plastic sip straws are used. As user draws liquid beverage into his or her mouth, the beverage passes through the cavity 22 in the inner tubular member 14 and the material of the inner tubular member 14 dissolves slowly and thereby imparts a flavor that mixes with the beverage that is being consumed.

By way of example, if a strawberry milk shake were being consumed through a chocolate inner tubular member 14, the consumer would taste a blend of the strawberry and the chocolate flavor thereby improving the strawberry milk shake drinking experience.

In the case of the chocolate inner tubular member 14, the thermal insulating properties of the paper outer tubular member 12 reduce the rate of heat transfer to the chocolate inner tubular member 14, both from the ambient air and from the user's hand.

The overall length of the sip straw according to the present invention 10 may be varied to accommodate beverage container of various sizes. The diameter of the sip straw 10 is proportioned to allow a user to easily sip a beverage through the cavity 22 or bore which is formed in the inner tubular member 14.

The outer tubular member 12 is formed of a waterproof paper as described above. Prior to being wound to form the outer tubular member 12, the waterproof paper wrapper has the general configuration of an elongated strip.

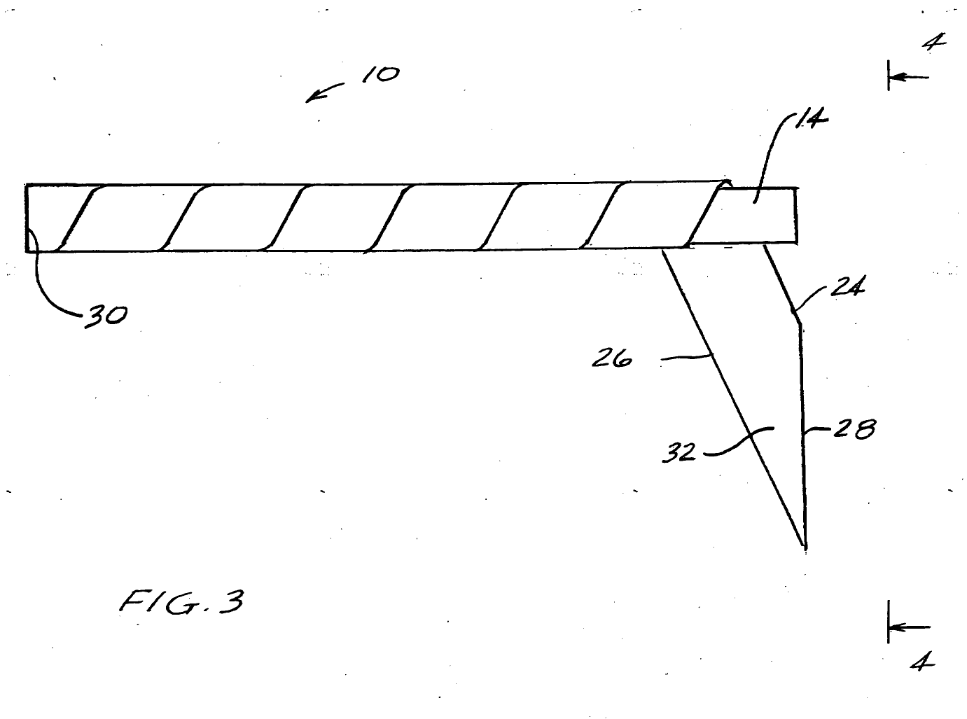

As shown in FIG. 3, the paper wrapper strip 16 which forms the outer tubular member 12 has a pair of relatively longer parallel edges 24, 26 and a pair of relatively shorter edges 28, 30.

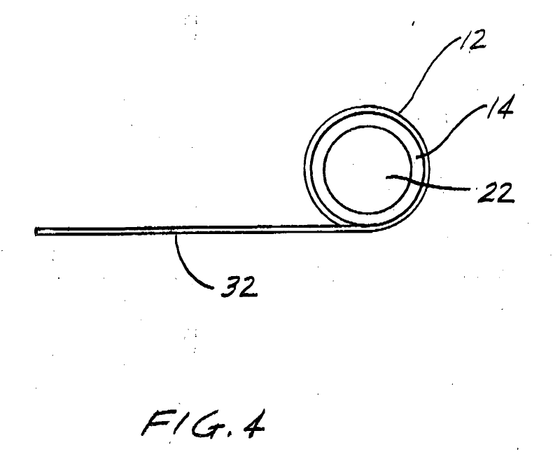

FIG. 3 and 4 show the end 32 of the outer tubular member 12 being partially unwound to provide access to the tubular inner member 14 which can be consumed.

The foregoing specific embodiments of the present invention as set forth in the specification herein are for illustrative purposes only. Various deviations and modifications may be made within the spirit and scope of this invention, without departing from a main theme thereof.

What is claimed is:

1. A sip straw with a consumable component comprising:
an outer tubular member;
an inner tubular member with said outer tubular member coextensive with said inner tubular member;
with said inner tubular member comprising a consumable material.

2. The sip straw with a consumable component as claimed in claim 1 wherein said inner tubular member comprises a candy material.

3. The sip straw with a consumable component as claimed in claim 1 wherein said inner tubular member comprises chocolate.

4. The sip straw with a consumable component as claimed in claim 1 wherein said inner tubular member comprises a food.

5. The sip straw with a consumable component as claimed in claim 1 wherein said inner tubular member comprises a medicinal material.

6. The sip straw with a consumable component as claimed in claim 1 wherein said outer tubular member comprises a paper member.

7. The sip straw with a consumable component as claimed in claim 1 wherein said outer tubular member comprises a spirally would paper strip.

8. The sip straw with a consumable component as claimed in claim 1 wherein said outer tubular member comprises a waterproof paper member.

9. The sip straw with a consumable component as claimed in claim 1 wherein said outer tubular member comprises a frangible member.

10. The sip straw with a consumable component as claimed in claim 1 wherein said inner tubular member comprises a paper strip having a pair of substantially parallel edges.

11. The sip straw with a consumable component as claimed in claim 1 wherein said inner tubular member comprises a soluble material.
